(19) United States
(12) Patent Application Publication
(10) Pub. No.: US 2013/0212621 A1
(43) Pub. Date: Aug. 15, 2013

(54) BROADCAST-ENABLED MEDIA HUB

(71) Applicants: MARK T. CORL, Princeton, NJ (US); RICHARD CHERNOCK, Lawrenceville, NJ (US)

(72) Inventors: MARK T. CORL, Princeton, NJ (US); RICHARD CHERNOCK, Lawrenceville, NJ (US)

(21) Appl. No.: 13/836,150

(22) Filed: Mar. 15, 2013

Related U.S. Application Data
(63) Continuation-in-part of application No. 12/927,565, filed on Nov. 18, 2010.

(51) Int. Cl. H04N 21/61

(52) U.S. Cl. CPC H04N 21/6112
USPC 725/33; 725/115; 725/112

(57) ABSTRACT

Provided is a method and system for caching broadcast segments provided by a broadcaster. Included are: obtaining signaling of particular program segments from the broadcaster using non-real-time data casting, obtaining an ATSC broadcast stream from the broadcaster, saving the particular program element segments to a high-priority broadcast cache and, tuning to a broadcast and saving program elements to a low-priority network cache. Also included are determining if the playback segment has an associated URL and allowing clients to obtain playback elements using a Web access method or a media distribution protocol if so. Otherwise, obtaining playback elements through only a media distribution method such as DLNA. In either case the obtained and cached elements are then reconstructed into a single coherent stream for continuous play.

### FIELD OF THE INVENTION

This invention generally relates to a broadcast-enabled media hub, and, more particularly, to providing a transparent proxy cache in conjunction with a router to allow high quality content from a terrestrial broadcast to replace Internet content for all devices on a home network.

### BACKGROUND OF THE INVENTION

Television broadcasters control a large digital transmission system that is currently being used almost entirely to deliver HD and SD TV to a small population. Many companies, including Triveni Digital, Inc. of Princeton Junction, N.J., have developed “data-casting” systems with some success. These systems have generally been used to transfer data to businesses or, more typically, educational and government facilities by a PBS affiliate. The Clear Channel station group released its “Delta V” service in 2002, which required a receiver to attach to a PC, adding up to 256K bandwidth to an individual user's Internet performance.

These “data-casting” systems have been used in the past to leverage the available broadcast digital transmission bandwidth, and have focused on either general IP acceleration or targeted delivery of data to a PC. The onset of more sophisticated devices such as tablets and smart phones increases the need for a hybrid system that accelerates the use of specific broadcaster content.

Pure Internet acceleration does not scale well with a large number of subscribers. The bandwidth required to supply a large number of users quickly outstrips the broadcaster's data capacity. The targeted delivery is limited in scope and does not allow a broadcaster to address the larger consumer marketplace.

Previous systems were intended for a single device, e.g., a home PC, to receive broadcast data and use it locally. The data sent was either generic Internet accelerated data that is very limited for large user bases or targeted data that is limited to a small audience.

Another problem with the prior use of broadcast data reception is that it requires a rather ungainly antenna combined with tuning hardware, e.g., a receiver, and is therefore problematic to use with a typical hand-held device. Additionally, each antenna, and receiver combination is costly and would operate on a single device only. Sharing the broadcast data among other devices in the home would require additional software applications.

Use of a transparent proxy cache in conjunction with a router is well-known. Terrestrial DTV broadcast data-casting, as noted above, has been deployed for a decade. Broadcasters currently pay significant amounts of money to transmit various content through an ISP and, often, through a content delivery network (CDN) in the ease of audio and video content. Often, broadcasters pay twice to distribute their content over the Internet and over the terrestrial broadcast. Using their broadcast channel to supply this data directly to the home, bypassing the Internet entirely, reduces the bit charges normally incurred.

In addition, the broadcasters' content is often lost in the vast amount of available content on the general Internet. Potential viewers often have difficulty finding local content that may be of interest to them.

Also, while virtually every hand-held or computer device has an Internet connection via WiFi or cellular, most do not have a TV antenna and, therefore, cannot connect directly to the broadcast content. This forces broadcasters to rely on typical Internet content delivery thereby relegating them to be just like all the other web sites. This often results in reduced content quality to reduce costs of distribution.

Thus, there is a need for a hybrid system suitable to a central home network location, which can accelerate most Internet accesses via caching and provide better value for select web data by receiving it through another channel; namely, the over-the-air broadcast. Such a system would also reduce broadcaster ISP charges for data provided over the Internet.

### SUMMARY OF THE INVENTION

An aspect of the present invention provides a system and method for caching broadcast segments and other data provided by a broadcaster. The system includes a DTV receiver and data storage (HDD), both in communication with a USB hub, the USB hub further in communication with a wireless router. The wireless router further includes a transparent proxy in communication with a network cache, and a cache manager further in communication with a media distribution protocol adaptor such as miniDLNA, a broadcast cache and a data receiver The router, proxy cache, network cache, cache manager, miniDLNA media distribution protocol manager, broadcast cache and data receiver, together comprise an electronic data circuit.

The methods include: obtaining, by the electronic circuit, from the broadcaster, an ATSC broadcast stream, obtaining, from the broadcaster using non-real-time (NRT) data casting, signaling of a particular program element segment schedule, the schedule comprising the time when a broadcast will be available, and saving the particular program element segments schedule to a high-priority broadcast cache. The methods further include, at the scheduled broadcast time, tuning to a broadcast and saving broadcast program elements to said hi-priority broadcast cache. If broadcast program elements are not available additional content is obtained from the Internet, and saved in a low-priority network cache.

In another aspect of the invention, the program element segments may include: content, HTML, images, documents, audio, audio-video, advertising, and URLs, and the like.

In another aspect of the invention, the above system and method further includes testing whether the playback segment has an associated URL. If so, playback elements are obtained from the cache using Web access methods, otherwise, they are obtained using only DLNA. Playback elements with associated URLs are available to clients using either DLNA or VVeb access methods. The obtained and cached data elements are then reconstructed into a single coherent stream for continuous play.

In a further aspect reconstructing further includes determining if obtained elements have changed playback, and, if not, using cached elements to reconstruct the single coherent stream.

In another aspect of the invention, a method and system for providing an emergency message to any device in communication with a broadcast-enabled media hub is provided. In this aspect, an ATSC broadcast stream is obtained from the broadcaster, and the stream is cheeked to determine if it includes an MEAS signal. If so, if the MEAS signal indicates an emergency for a location of the media hub, all page requests are then substituted with a page that indicates an emergency is taking place.

### BRIEF DESCRIPTION OF THE DRAWINGS

FIG. 1 is a block diagram of a broadcast-enabled media hub system that is useful for understanding the present invention.

FIG. 2 is a block diagram of additional details of a broadcast-enabled media hub system that is useful for understanding the present invention.

FIG. 3(a) is a flow diagram of an exemplary method for operation of the broadcast-enabled media hub that is useful for understanding the present invention.

FIG. 3(b) is a now diagram of an exemplary method for operation of the broadcast-enabled media hub that is useful for understanding the present invention.

FIG. 4 is a flow diagram of an exemplary method for providing a network emergency alert that is useful for understanding the present invention.

FIG. 5 is a flow diagram of an exemplary method for using advertising encode keys that is useful for understanding the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

Similarly, communication between system elements, for example, in FIGS. 102, 104, 106, 108, 110, 112, 114, 116, 118, and 202-218, is assumed to be over conventional communication lines and interfaces, unless otherwise indicated, without limitation as is understood in the art.

The present invention advantageously provides a hybrid “transparent proxy” caching service for use with a router that is tuned to return available cached broadcast data instead of the data received from the internet. Thus, the requesting hand-held device—or any other device operating through the router—will receive data cached from the broadcast instead of the data fetched from the internet.

By creating a hybrid system and moving it to a central Home network location, the present invention can accelerate most Internet accesses via caching and provide better value for select web data by receiving it through another channel; namely, the over-the-air broadcast. This also reduces broadcaster ISP charges for their data over the internet.

The present invention also advantageously provides relief to broadcasters, who previously had to pay twice to distribute their content over the Internet and over the terrestrial broadcast.

The present invention also advantageously allows potential viewers to find and access local broadcast content that may be of interest to them seamlessly and automatically.

### Exemplary System of the Present invention

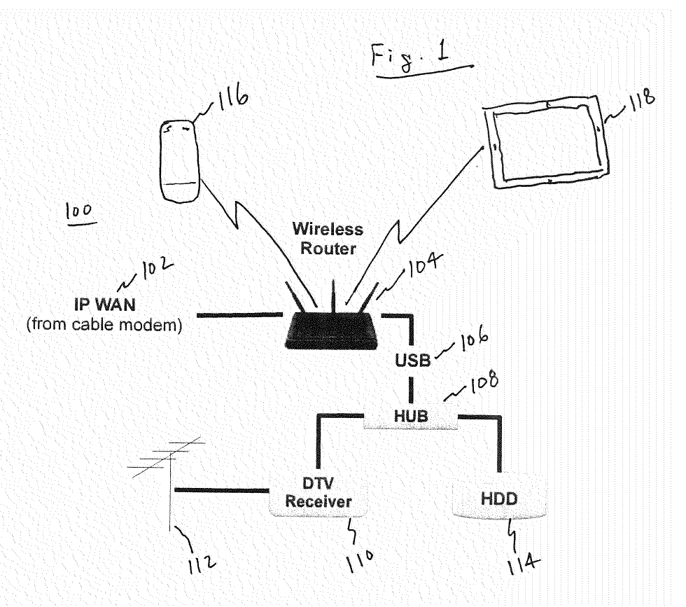

FIG. 1 depicts an exemplary broadcast-enabled router-integrated home media server system 100. In an embodiment of the invention, a wireless router 104 is connected, such as by USB 106, to a hub 108. The wireless router 104 may be, for example, a Cisco Linksys E4200 with DD-WR T Linux OS, and the hub 108 may be an Apricorn Aegis Netdock with 4 ports. The hub 108 is further operatively connected to a high density drive, HDD 114, such as a 1 terabyte (TB) or greater hard disk contained in Netdock. The hub 108 is also operatively connected to a DTV receiver 110, such as a Hauppage WinTV Aero-M ATSC M/H USB dongle with built-in antenna 112. The router is also in communication/connection with one or more of an IP Wide-Area Network (IP WAN) 102, and/or any number of mobile devices, such as but not limited to a smartphone 116 and/or a tablet computing device 118 or portable media player (not depicted), or the like. A typical implementation of the system 100 is as 2 boxes connected via USB 106 with a WinTV dongle plugged into a Netdock enclosure

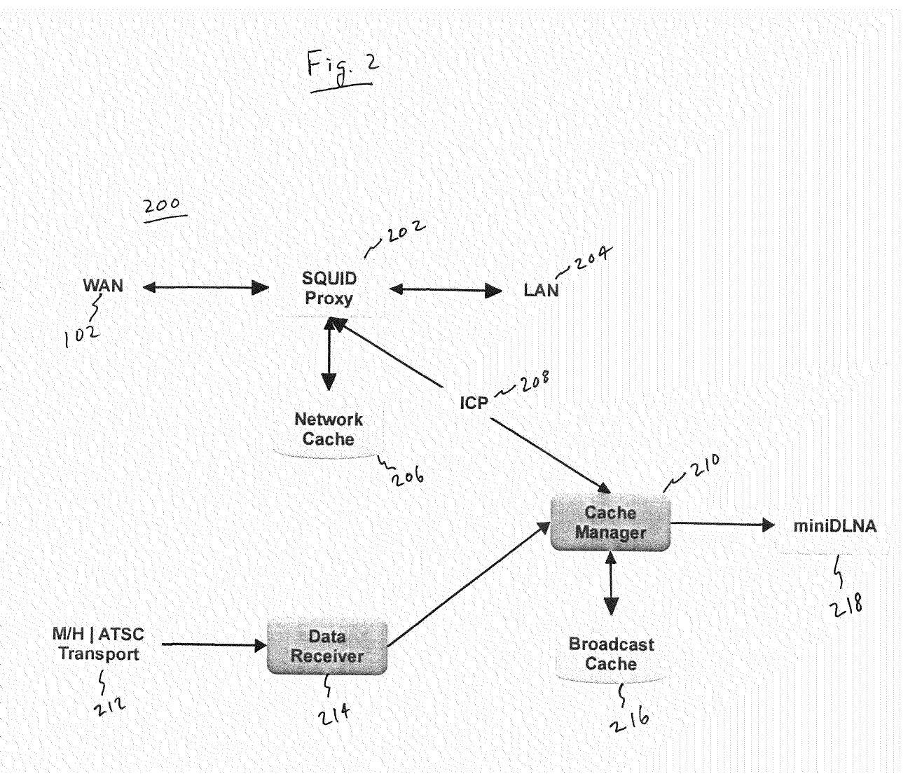

FIG. 2 further describes the components and connections 200 of an exemplary router 104 in an embodiment of the invention. Router modules include an off-the-shelf transparent caching proxy—a.k.a. SQUID proxy 202 with either or both a WAN 102 and LAN 204 connection. The SQUID proxy 202 may be an open source implementation of a network proxy, or, alternatively, any transparent caching software may be used. The SQUID proxy 202 maintains a network cache 206 and communicates with a cache manager 210, such as by ICP 208 (internet Cache Protocol—RFC 2186). The cache manager 210 may be Linux-based with the various drivers needed to support HDD and DTV reception. Triveni Digital, Inc. offers a cache manager for data received from broadcast.

The cache manager 210 is further m operative communication with a DLNA protocol Manager—miniDNLA 218, a broadcast cache 216, and a data receiver 214, such as but not limited to a SkyScraper data receiver with NRT M/H support in communication with a M/H/ATSC broadcast 212.

Because nearly all homes with multiple wired or wireless devices connecting to the Internet require a router 104 that can route the appropriate network packets from the requesting device to the network and back, the router 104 represents a single architectural pinch point for caching content which may be used by devices on the home network In the alternative, the router 104 also represents an advantageous point for management control and to limit access to content, or replace content with alternatives.

The router 104 preferably also provides standard routing and firewall capabilities. The SQUID proxy 202 preferably provides transparent caching and saves content locally indexed by URL. The ATSCDTV receiver 110 preferably decodes data and stores it to a separate cache 216 via a cache manager 210. The separate cache 216 is accessible and of higher priority than the network cache 206. The cache manager 219 preferably interacts with the SQUID proxy 202 via standard protocol. Once data is in the separate cache 216, the SQUID proxy will return the cached data until the remote content changes. Use of a transparent proxy, such as the SQUID proxy 202, allows all URLs to be managed efficiently, using hierarchical Web technology, which allows multiple caches to be accessed and managed through Internet Cache Protocol (ICP). A large disk subsystem—e.g., HDD 114—of 1 terabyte or more preferably provides for extensive caching of media data.

In an alternative embodiment, ATSC NRT data reception—standard or M/H—provides a mechanism for delivering content outside standard ISP methods. This implementation can provide relatively small amount of data to large audiences, or specific high value data that can be filtered and personalized for a smaller audience. Other media delivery protocols, such as but not limited to DLNA, may be used to provide HTTP-alternative access to cached media content. Content may need to be encrypted to allow it to be stored for reuse.

It is understood that system 100 components including but not limited to the router 104, hub 108, DTV receiver 110 and HDD 114, and also various modules incorporated with the router 104, such as but not limited to, the SQUID proxy 202, network cache 206, cache manager 210 miniDLNA media distribution protocol manager 218, broadcast cache 216 and data receiver 214 include one or more processors in operative communication with electronic memory and interfaces, configured as needed to provide the operating procedures and methods as described herein.

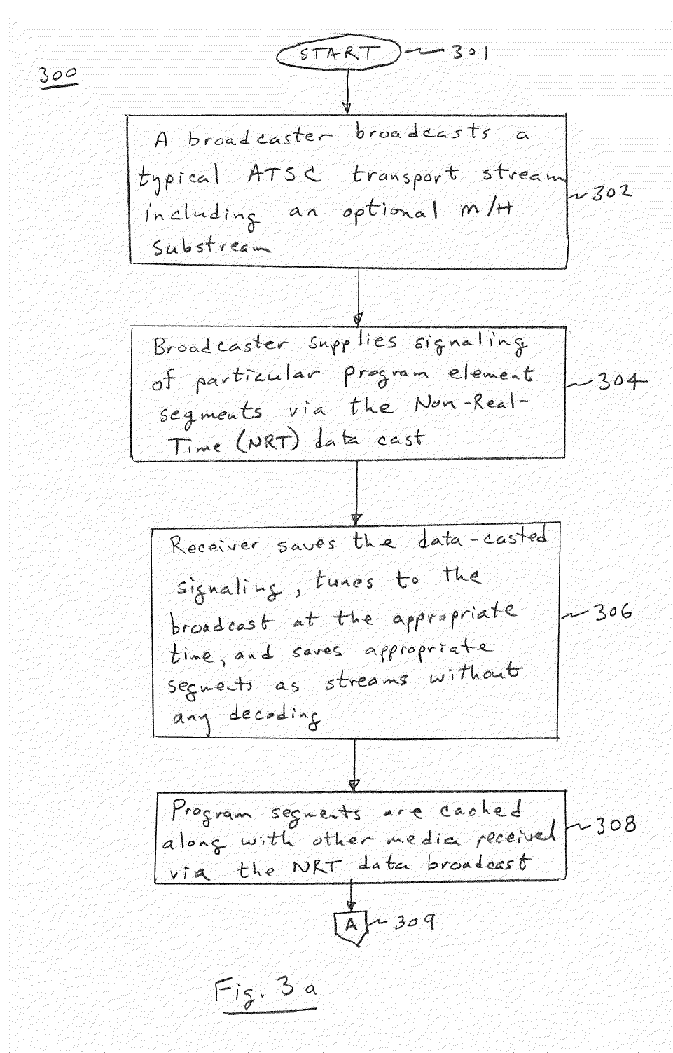

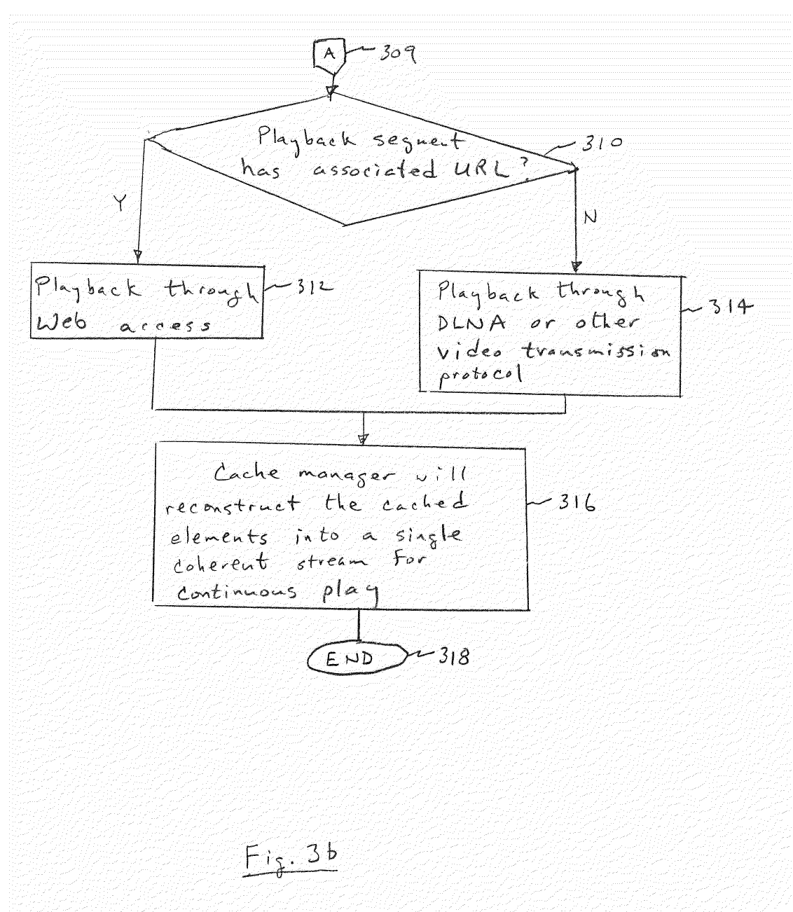

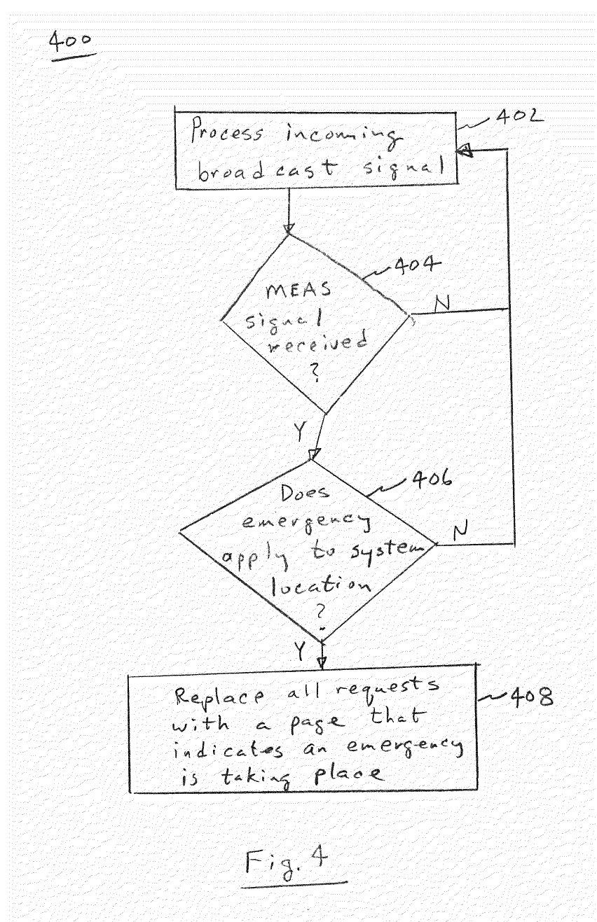

As noted above, the system 100 implements methods for controlling functions of software applications based on a location and/or an activity of a person or mobile object. Exemplary embodiments of such methods will now be described in relation to FIGS. 3 and 4.

### Exemplary Methods of the Present Invention

In operation in an embodiment of the invention, the router 104 provides standard routing and firewall capability. The SQUID proxy 202 transparently caches remote content locally indexed by URL, and the ATSC DTV receiver decodes data and stores it to a separate cache that is accessible and of higher priority than the normal cache. The broad data cache management interacts via standard protocol (ICP) with the SQUID proxy 202. Once data is in the cache, the SQUID proxy 202 will return the cached content until the remote content changes.

The broadcast-enabled wireless router 104 can be extended to use the entire broadcast channel by observing that the audio and video data is another data broadcast medium—albeit one that can be viewed directly by ATSC compliant devices. Thus, the device uses the entire broadcast including the primary ATSC broadcast with MPEG2 HD or SD video, AC3 audio, and any content over the ATSC M/H carrier included in the broadcast. This functionality is similar to a Digital Video Recorder (DVR) built into many cable set top boxes or TIVO but differs in several ways. For example, with the inventive system 100, the broadcaster is the primary selector of content to be cached, not the end user.

In an embodiment of the invention, the system 100 operates as depicted in FIG. 3a. The method 300a begins at step 301. In step 302, a broadcaster broadcasts a typical ATSC broadcast stream including an optional M/H sub-stream. At step 304, the broadcaster supplies signaling of particular program element segments via the Non Real Time data cast—either in the regular broadcast or in the M/H sub-stream. The signaling delivered over the data cast precedes the actual program elements in order to allow the receiver to tune to the broadcast at the appropriate time. The local device could resolve schedule conflicts between broadcasters by using viewing tendencies and preferences to select the program content. If the content is not saved, it will simply not be in the local cache. It will still be accessible from the Internet albeit in perhaps lower quality. The signaling will identify segments of the incoming stream of video which are then saved separately, and will also bind segments into a logical whole. For example, a given television program would be divided into segments including the program and perhaps selected ads These ads can be replaced at a later tune when the program is played back. The signaling would also include universal resource locations (URLs) identifying the segments as being able to be played from within web sites and any keys if the video is encrypted

At step 306, the receiver saves the data ousted signaling, tunes to the broadcast at the appropriate time and saves appropriate segments as program streams without any decoding. The program segment save operation essentially is repackaging from broadcast to program stream allowing less powerful receivers to be used. No transcoding needs to take place. The receiver may receive signaling information from multiple broadcasts. In this case, the receiver would need to switch between channels by combining the content. As described above, a priority scheme could be used based on various usage parameters or the consumer could select preferred broadcasts explicitly. It may be necessary to encrypt certain programming elements to comply with broadcaster content rules.

At step 308, the program segments are then cached along with other media received via the NRT data broadcast. As noted above, the signaling can contain a URL allowing the cached element to be retrieved simply by accessing the appropriate URL. If not then the program segments will only be available via a protocol other than HTTP. The caching being complete 309, playback is further described in FIG. 3b.

Referring now to FIG. 3b, the method 300b continues. At step 310, playback is through web access when the segment has an associated URL, step 312, or via DLNA or some other video transmission protocol when no URL is supplied, step 314. In either case, at step 316 the cache manager will reconstruct the cached data elements into a single, coherent stream if played continuously. The cached elements used can change over time for any given logical stream. The signaling information will contain the expected duration of any such segment. Individual broadcasters will determine the rules for replacing advertising segments. This allows various schemes to be implemented to allow consumers to “opt out” of ads. An instrumented playback or usage system can provide metrics on individual advertising and segments, which can be sent back to the broadcaster.

In an optional embodiment, an end-user might be allowed to identify programs to be stored, although the selection may be limited due to single timer. It is expected that this would only be available if the broadcaster was not using the channel to transmit content. User preferences—explicit or implied—may be used to select and prioritize program element storage and cache constraints. Optimally, the device would have multiple timers. However, conflicts would be minimized since the broadcast is not being watched directly with this particular device. Collaboration between broadcasters would be useful to allow larger library of content with less overlap.

This mechanism allows commercial replacement at receiver since alternative advertisement may be supplied via NRT or within another broadcast. Broadcasters could also broadcast “ad collections” during early morning hours containing all ads to be reused during coming days or weeks. The actual replacement is trivial since scheduling of the appropriate elements is done as segments are played back as a linear program. The cache manager simply picks a different segment to play back for the specific advertisement to be replaced.

Format “impedance”, that is, the resolution and layout of the video, may need to be matched from segment to segment. Format info can be contained in signaling. In a worst case scenario, multiple formats will need to be created or supplied in broadcast. Broadcasters can settle on a single format for these broadcasts thereby limiting the problem. Alternatively, the router media hub could create multiple formats supplying them based on the requesting client format. This is currently done by most content delivery networks (CDNs) and TV Everywhere services as well as recent editions of TIVO DVRs.

An additional embodiment of the invention provides for the system 100 to support network emergency alerts. A depicted in the exemplary method 400 of FIG. 4, the broadcast enabled wireless router media hub system 100 can be extended to allow emergency alert messages to be propagated to any web-enabled client device. The emergency alert extension depends on two technologies provided by the media hub 108: 1.) reception of Mobile ATSC (M/H) and the corresponding Mobile emergency Alert System protocol (MEAS); and 2.) the transparent, caching SQUIUD proxy 202 which allows substitution of web sites with cached or replacement content.

Home users of the Internet typically have no indication of a life threatening or severe emergency unless some other mechanism for notifying them is available, such as regular broadcast or cable TV. If the TV is not on, there may be no way for an emergency alert to be communicated. Some municipalities are now sending out text messages as cell phone alerts, but these are based entirely on address of the person with the telephone number and may easily be missed if the person does not regularly carry their cell phone at home.

As described above, the system 100 is continuously processing the incoming broadcast signal 402 to provide features such as rich media, ad replacement, etc. While this is occurring, the system 100 detects when an MEAS signal is received 404. When an MEAS signal is received, the media hub 108 will decode it and determine if the emergency applies to its location 406 Note that since the hub will typically never be moved, this location is fixed and well known. As client devices access pages on the Internet, the media hub will replace all requests with a page that indicates an emergency is taking place 408.

The returned page can be customized based on the particular emergency severity and user preferences. An example of low priority emergency would be a simple top message bar or bottom crawl containing the emergency message text. The page returned would contain this top crawl HTML with a frame containing the actual requested message or content from the local broadcast cache which would continue to operate as normal.

More severe emergencies could cause the media hub proxy to respond to every page request with the same emergency page containing other enhanced emergency information delivered over the broadcast. In addition to the actual information supplied on the replaced page, the page could link to other instructions on the web or to more video regarding the emergency.

In a preferred embodiment of the invention, every device communicating with the Internet through the wireless router 104/SQUID proxy 202 using a browser would receive the emergency message including smart phones, tablets, connected TVs, and computers.

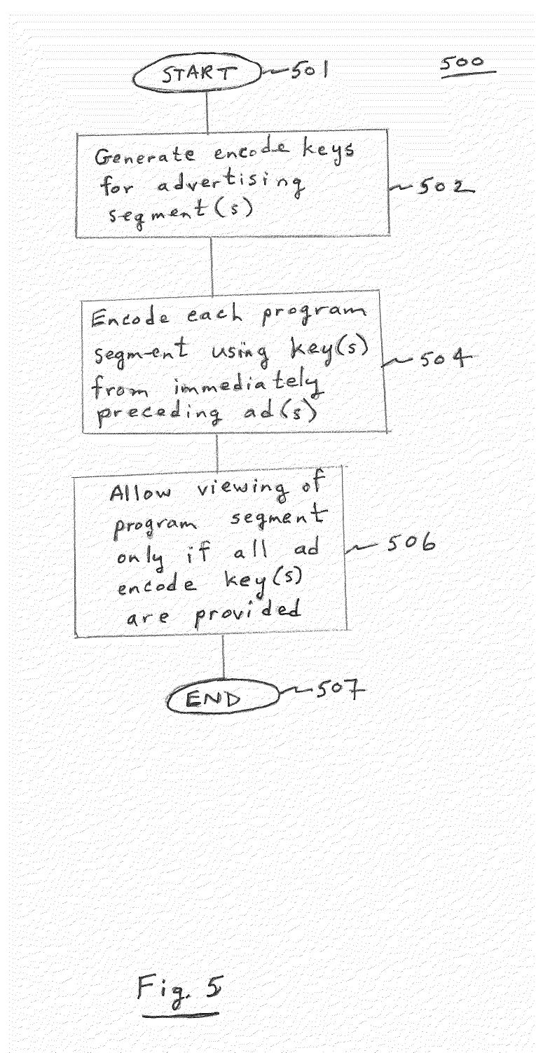

Another embodiment of the invention provides for Ad-based decryption. FIG. 5 depicts an exemplary method 500 for using tying encoding keys to selected advertising content segments. This may be performed concurrently with the method described above in FIG. 3a, steps 301-308 The method begins at step 501, and proceeds to step 502, where encode keys to content decryption are generated for advertising segment(s). Each segment of a program is encoded using keys from the immediately preceding ad(s) in step 504. The generated key(s) are extracted after the advertising is viewed, thereby allowing the next segment to be decoded. A program segment can only be viewed is all the ad encode key(s) are provided 506.

Ad-based decryption offers highly versatile options for broadcasters/advertisers. Since each segment of a program is encoded using keys from the immediately preceding ad(s), the consumer would necessarily need to watch all the ad(s) in order to view the program segment. Thus, consumers could watch the entire program by watching all the ad(s), or may limit or eliminate ad(s) in several ways, at the discretion of the broadcaster. For example, the consumer may fill out a preference form, allowing the broadcaster to restrict the ad(s) to only those to which the consumer is interested. In this scenario, for example, the consumer may still be required to view one ad per program segment

Similarly, in another example, the consumer might pay a subscription fee to remove all advertising, essentially buying the ad(s). This could be done on a show-by-show basis on an overall monthly basis. This approach would also provide a means to implement pay-per-view.

Ad-based decryption requires a dedicated decryption device, such as STB/DVR/media nub, or the like, that maintains content in an encrypted form

In an exemplary embodiment of the invention, a system and method for caching broadcast segments provided by a broadcaster using an exemplary broadcast-enabled media hub is provided. The system utilizes a DTV receiver and data storage (HDD), both in communication with a hub, winch is further in communication with a wireless router. The wireless router includes a transparent proxy in communication with a network cache, and a cache manager in communication with the miniDLNA media distribution protocol manager, a broadcast cache and a data receiver. The router, proxy cache, network cache, cache manager, miniDLNA media distribution protocol manager, broadcast cache and data receiver include an electronic data circuit, which is configured to perform the exemplary method.

The method includes obtaining, by an electronic circuit, from the broadcaster, an ATSC broadcast stream, obtaining, by the electronic circuit, from the broadcaster using non-real-time data casting, signaling of particular program element segments; saving, by the electronic circuit, and the particular schedule of program element segments to a high-priority broadcast cache.

If the playback segment has an associated URL, playback elements may be accessed from cheats using Web access methods or some alternative media distribution protocol such as DLNA. Otherwise, playback elements are available only through a media distribution protocol such as DLNA Next, the electronic circuit reconstructs the obtained and cached elements into a single coherent stream for continuous play. In one embodiment, the cached elements are incorporated into the coherent stream based on cache priority—e.g., high priority cached items are included before related lower priority cached items.

A further exemplary method of the present invention includes the provision of a network emergency alert. In a system and method such as described herein, the electronic circuit further determines if the ATSC broadcast stream includes an MEAS signal, and if so, if the MEAS signal indicates an emergency for a location of the media hub. If so, the electronic circuit replaces all page requests with a page that indicates an emergency is taking place.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method for caching broadcast segments provided by a broadcaster, comprising:
obtaining, by an electronic circuit, from the broadcaster, an ATSC broadcast stream;
obtaining, by said electronic circuit, from the broadcaster using non-real-time (NRT) data casting, signaling of a particular program element segment schedule, the schedule comprising the tune when a broadcast will be available;
saving, by said electronic circuit, the particular program element segments schedule to a high-priority broadcast cache;
at the scheduled broadcast time, tuning, by said electronic circuit, to a broadcast and saving broadcast program elements to said hi-priority broadcast cache;
if broadcast program elements are not available, obtaining, by said electronic circuit, additional content from the Internet;
saving, by said electronic circuit, said additional content in a low-priority network cache.

2. The method according to claim 1, further comprising:
if the playback segment has an associated URL, local clients obtaining playback elements using Web access methods or other media distribution protocols such as DLNA, otherwise, obtaining playback elements only through media distribution protocols such as DLNA; and
reconstructing, by the electronic circuit, the obtained and cached elements into a single coherent stream for continuous play, said cached elements stored in high-priority cache used in place of similar low-priority cached elements.

3. The method according to claim 2, wherein the reconstructing further comprises determining, by the electronic circuit, if obtained elements have been updated and if not, using cached elements to reconstruct the single coherent stream.

4. The method according to claim 3, wherein the particular program element segments are selected from the group comprising: content, HTML, images, documents, audio, audio-video, advertising, and URLs.

5. The method according to claim 3, wherein the particular program element segments are selected by the broadcaster.

6. A method for providing an emergency message to any device in communication with a broadcast-enabled media hub, the method comprising:
obtaining, by an electronic circuit of the media hub, from the broadcaster, an ATSC broadcast stream;
determining by the electronic circuit, if the ATSC broadcast stream includes an MEAS signal, and if so, if the MEAS signal indicates an emergency for a location of the media hub, and if so, replacing, by the electronic circuit all page requests with a page or portion of a page that indicates an emergency is taking place.

7. A broadcast-enabled media hub system, comprising:
a DTV receiver and data storage (HDD), both in communication with a hub, the hub further in communication with a wireless router;
the wireless router further comprising a transparent proxy in communication with a network cache, and a cache manager further in communication with a media distribution protocol manager such as miniDLNA, a broadcast cache and a data receiver;
the router, proxy cache, network cache, cache manager, a media distribution protocol manager such as miniDLNA, broadcast cache and data receiver further comprising an electronic data circuit;
the electronic circuit configured to perform the steps of:
obtaining, by an electronic circuit, from the broadcaster, an ATSC broadcast stream;
obtaining, by said electronic circuit from the broadcaster using non-real-time (NRT) data casting, signaling of a particular program element segment schedule, the schedule comprising the time when a broadcast will be available;
saving, by said electronic circuit, the particular program element segments schedule to a high-priority broadcast cache;
at the scheduled broadcast time, tuning, by said electronic circuit, to a broadcast and saving broadcast program elements to said hi-priority broadcast cache;
if broadcast program elements are nor available, obtaining, by said electronic circuit, additional content worn the Internet;
saving, by said electronic circuit, said additional content in a low-priority network cache.

8. The system according to claim 7, wherein said electronic circuit is further configured to perform the additional steps of:
if the playback segment has an associated URL, clients obtaining playback elements using Web access methods or other media distribution methods such as DLNA, otherwise, obtaining playback elements only through media distribution methods such as DLNA; and
reconstructing, by the electronic circuit, the obtained and cached elements into a single coherent stream for continuous play, said cached elements stored in high-priority cache used in place of similar low-priority cached elements.

9. The system according to claim 7, wherein said electronic circuit is further configured to provide for a network emergency alert by performing the additional steps of:
determining by the electronic circuit, if the ATSC broadcast stream includes an MEAS signal, and if so, if the MEAS signal indicates an emergency for a location of the media hub, and if so,
replacing, by the electronic circuit all page requests with a page that indicates an emergency is taking place.

10. The system according to claim 7, wherein the particular program element segments are selected from the group comprising: content, HTML, images, documents, audio, audio-video, advertising, and URLs.

11. The system according to claim 7, wherein the particular program element segments are selected by the broadcaster.
